(19) United States
(12) Patent Application Publication
(10) Pub. No.: US 2009/0125939 A1
(43) Pub. Date: May 14, 2009

(54) Television capable of and method for changing output effect based on program type

(75) Inventor: Chao-Wei Huang, Taipei Hsien (TW)

Correspondence Address: OLIFF & BERRIDGE, PLC, P.O. BOX 320850, ALEXANDRIA, VA, 22320-4850, US

(73) Assignee: ACER INCORPORATED, TAIPEI HSIEN (TW)

(21) Appl. No.: 12/081,083

(22) Filed: Apr. 10, 2008

(30) Foreign Application Priority Data
Nov. 13, 2007 (TW) 096142931

(51) Int. Cl. H04N 5/445

(52) U.S. Cl. 725/39

(57) ABSTRACT

A television capable of and a method for changing an output effect based on program types are provided. The television stores a lookup table recording the corresponding relationship between program types and scenario modes and receives a television program signal containing a program type information so as to search the scenario mode corresponding to the program type from the lookup table. Then the television adjusts the output effect, such as an image display effect or an audio output effect based on the searched scenario mode.

### BACKGROUND OF THE INVENTION

1. Technical Field

The present invention relates to televisions and, more particularly, to a technology enabling a television to change its output effect based on types of programs to be displayed.

2. Description of Related Art

A contemporary digital television typically comprises an OSD (On Screen Display) processor for allowing users to set various image parameters, such as brightness, saturation or color temperature, so as to allot a desirable display effect to various types of programs. While it would be a time-consuming job for users to set the image parameters one by one, most televisions provide many scenario modes containing preset default values of image parameters or audio parameters instead, so that users can directly switch the television among the scenario modes corresponding to the type of the program to be displayed. For instance, when a basketball game is to be displayed, a sport mode can be designated, and for displaying a talk show, the television can be switched to a static mode so that the television can change the output effect based on the predetermined parameters contained in the scenario mode the user selected. Such approach frees users from complex parameter setting while the desirable display effect can be achieved thereby.

Though the desirable display effect can be achieved by users' selection among the scenario modes, it is still troublesome that when changing channels to watch programs of other types, the users have to manually switch the scenario modes to obtain the desirable display effect. Besides, for facilitating the user's quick selection, the scenario modes set in the televisions are usually not rich enough to achieve optimum display effect in all program types.

In view of the above-mentioned problems of the prior arts, the inventor of the present invention, on the strength of his research and practical experience, proposes a television capable of and a method for changing an output effect based on program types, so as to overcome the foregoing defects.

### SUMMARY OF THE INVENTION

Therefore, it is one objective of the present invention to provide a television capable of and a method for changing an output effect based on program types so as to enhance an output effect of displayed frames while freeing users from manually switching the television among scenario modes.

Based on the present invention, the television capable of changing an output effect based on program types, comprises a receiving unit, a storage unit, a processing unit and an output unit. The receiving unit is for receiving a program classification and a television program signal containing a program type information. The storage unit is for storing at least one setting parameter, and a lookup table recording the corresponding relationship between a plurality of program types and a plurality of scenario modes. The processing unit is for determining the type of the program being displayed based on the program classification list, and select a corresponding scenario mode from the lookup table.

Therein, the scenario mode preferably contains at least one image parameter or at least one audio parameter.

Therein, the output effect preferably contains an image display effect or an audio output effect of the television.

Moreover, the present invention provides a method for changing an output effect based on program types. The methods is applicable to a television and comprises following steps: providing a program classification list and a lookup table recording the corresponding relationship between a plurality of the program types and a plurality of scenario modes and storing the same in the television; receiving a television program signal containing a program type information at the television; selecting the scenario mode corresponding to the program type information from the lookup table based on the program classification list; and adjusting the output effect of the television based on the selected scenario mode.

Based on the above description, the television capable of and the method for changing an output effect based on program types have the following advantages:

(1) The television changes the output effect based on program types and therefore enhances convenience of switching among scenario modes.

(2) The television changes the output effect based on program types and therefore facilitates achieving the desirable output effect without limitation of finite options of the scenario modes.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a block diagram of a television capable of changing an output effect based on program types disclosed in the present invention;

FIG. 2 is a flow chart of a method for changing an output effect thereof based on program types disclosed in the present invention;

FIG. 3 shows an embodiment of the television capable of changing its output effect based on program types disclosed in the present invention;

FIG. 4 shows scenario modes of the television capable of changing its output effect based on program types disclosed in the present invention; and

FIGS. 5A through 5C illustrate another embodiment of the television capable of changing its output effect based on program types disclosed in the present invention.

### DETAILED DESCRIPTION OF THE PREFERRED EMBODIMENT

In the following description, some preferred embodiments are to be explained in company with the drawings for illustrating the disclosed television capable of and the disclosed method for changing an output effect based on program types.

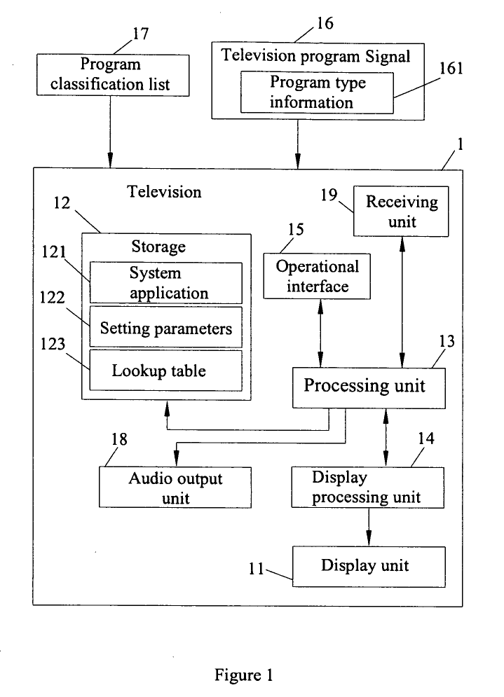

Please refer to FIG. 1 for a block diagram of a television capable of changing an output effect based on program types disclosed in the present invention. Therein, the television 1 comprises a display unit 11, a storage unit 12, a processing unit 13, a display processing unit 14, an operational interface 15, an audio output unit 18 and a receiving unit 19. The receiving unit 19 is for receiving a television program signal 16 and a program classification list 17, and the television program signal 16 contains a program type information 161, such as a movie type information, a sport type information, an animation type information, an adult movie type information, a news type information and so on. The program type information 161 usually represent as a index code, such as 0x11 or 0x1f, and the program classification list 17 records the index code of all defined program types of TV system.

The storage unit 12 stores a system application 121, a plurality of setting parameters 122 and a lookup table 123 recording the corresponding relationship between program types and scenario modes.

The setting parameters 122 are parameters related to the output effect of the television 1, such as image parameters, audio parameters or de-interlacing parameters. The image parameters are for adjusting the output effect of the display unit 11, preferably include an image brightness value, an image saturation value, an image color temperature value, an image gamma value or a de-interlacing parameter. Each scenario mode contains a predetermined value of at least one setting parameter 122 and corresponds to at least one program type. The corresponding relationship is recorded in the lookup table 123.

The processing unit 13 is provided for executing the system application 121 so as to determine the type of the program to be played based on the program classification list 17 and the program type information 161, and then select a scenario mode corresponding to said program from the lookup table 123. The processing unit 13 transmits the default value of the setting parameters 122 contained in the selected scenario mode to the display processing unit 14, and the display processing unit 14 drives the display unit 11 to display image based on the setting parameters 122, so that the user can watch said program in the selected scenario mode with better experience.

Besides, the processing unit 13 also drives the audio output unit 18 based on the predetermined value of the audio parameters contained in the selected scenario mode for adjusting the audio output effect of the television 1. The operational interface 15 allows a user to execute the application 121 and is preferably a keypad or a touch panel settled on the television or a remote control.

For example, when the television 1 is about to display a program which is golf type, since green lawns typically appear in such program, the scenario mode corresponding to the golf type preferably contains a relatively higher value of green color parameter so as to present the lawns with verdancy and provide desirable image display effects to user. Alternatively, when the program to be displayed through the television 1 is of a news type, the scenario mode corresponding to the news type preferably contains a parameter of turning-off surround sound effect. On the contrary, when the television 1 is to display a program of the movie type, the scenario mode corresponding to the movie type preferably contains a parameter of turning-on surround sound effect.

The display unit 11 is preferably a display panel. The storage unit 12 is preferably a memory. The processing unit 13 is preferably a microprocessor. The display processing unit 14 is preferably an OSD (On Screen Display) processor. The program classification list 17 is preferably a content descriptor provided by the DVB-T (Digital Video Broadcasting-terrestrial) set forth by the EBU (European Broadcast Union). Besides, the program classification list 17 can be built in the television 1.

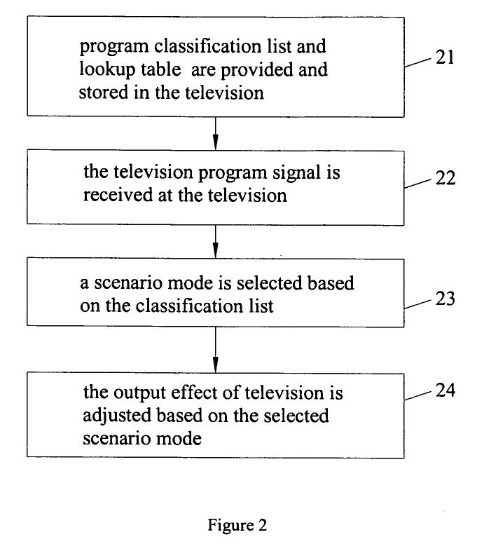

FIG. 2 illustrates a flow chart of a method for changing an output effect based on program types disclosed in the present invention. The method is applicable to a television that receives a television program signal. The television program signal contains a program type. The method comprises following steps. In step 21, a program classification list and a lookup table recording the corresponding relationship between program types and a scenario modes are provided and stored in the television, wherein the scenario mode contains at least one image parameter or at least one audio parameter. The program classification list records the index code of all defined program types of TV system. In step 22, the television program signal containing a program type information are received at the television.

In step 23 the scenario mode corresponding to the program type information of the program to be played is selected from the lookup table based on the classification list. Each scenario mode contains a predetermined value of at least one setting parameter which is used to adjusting the video effect or audio effect of the television.

In step 24 the output effect of the television is adjusted based on the selected scenario mode, for example, If a golf program is ready to display, after executing the mentioned above step, the television can enhance the green color tone and brightness of the frame automatically, so that the user can enjoy the golf program with better experience. If the user changes channel to watch a movie program, the television will recover the green color tone and brightness of the frame, and turn on surround sound effect automatically, then user can continuously enjoy the movie program without manually adjusting setting parameter.

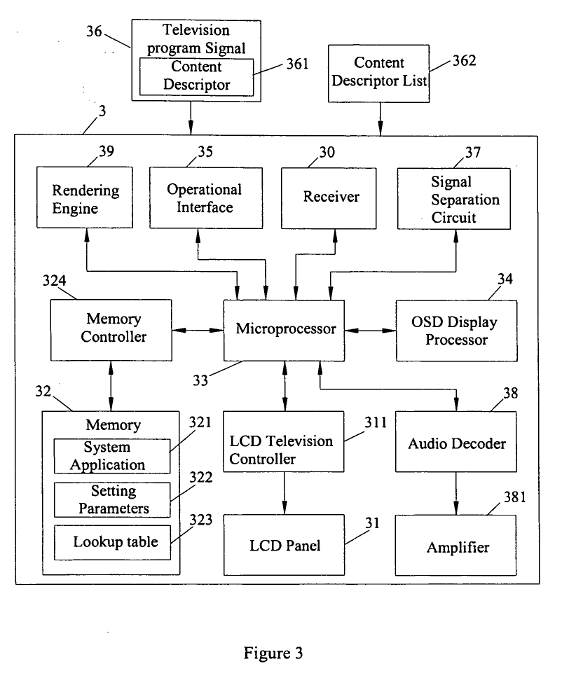

FIG. 3 illustrates an embodiment of the television capable of changing its output effect based on program types disclosed in the present invention. A television 3 receives a content descriptor list 362 and a television program signal 36 containing a content descriptors 361. Referring to Table 1 provided below, a content descriptor list 362 provided by DVB-T set forth by the EBU is shown as one example of the content descriptor list 362. Through the list, it is learned that the television program signal 36 includes two levels of content descriptors, wherein the content descriptors of a level_{—}1 cover 0x0˜0x3 while the content descriptors of a level_{—}2 cover 0x0˜0xE. Each the content descriptor corresponds to a program type. For example, the content descriptor (0x1,0x0) corresponds to a movie program while the content descriptor (0x2,0x1) corresponds to a weather forecast program.

TABLE 1

| Content_nibble_level_1 | Content_nibble_level_2 | Description |
|---|---|---|
| 0x0 | 0x0 to 0xF | undefined content |
| | | Movie/Drama: |
| 0x1 | 0x0 | movie/drama (general) |
| 0x1 | 0x1 | detective/thriller |
| 0x1 | 0x2 | adventure/western/war |
| 0x1 | 0x3 | science fiction/fantasy/horror |
| 0x1 | 0x4 | comedy |
| 0x1 | 0x5 | soap/melodrama/folkloric |
| 0x1 | 0x6 | romance |
| 0x1 | 0x7 | serious/classical/religious/historical movie/drama |
| 0x1 | 0x8 | adult movie/drama |
| 0x1 | 0x9 to 0xE | reserved for future use |
| 0x1 | 0xF | user defined |
| | | News/Current affairs: |
| 0x2 | 0x0 | news/current affairs (general) |
| 0x2 | 0x1 | news/weather report |
| 0x2 | 0x2 | news magazine |
| 0x2 | 0x3 | documentary |
| 0x2 | 0x4 | discussion/interview/debate |
| 0x2 | 0x5 to 0xE | reserved for future use |
| 0x2 | 0xF | user defined |
| | | Show/Game show: |
| 0x3 | 0x0 | show/game show (general) |

The television 3 comprises a receiver 30, an LCD panel 31, an LCD television controller 311, a memory 32, a microprocessor 33, a memory controller 324, and OSD display processor 34, an operational interface 35, a signal separation circuit 37, an audio decoder 38, a rendering engine 39 and an amplifier 381.

The receiver 30 is used to receive the television program signal 36 and the content descriptor list 362. The television program signal 36 is preferably transmitted in a form of a digital signal so that while external noise is removed therefrom, improved image and sound quality can be achieved. Furthermore, since the signal is digitally processed, additional information, such as multi-language subtitles, frames from various viewpoints, performers' profiles and racing statistics, may be added into the television program signal 36 to flesh the program out. The television program signal 36 is divided into a digital image signal and a digital audio signal by the signal separation circuit 37, wherein the digital audio signal is further decoded by the audio decoder 38 and then output by the amplifier 381. The rendering engine 39 generates an image frame based on the digital image signal and the LCD television controller 311 drives the LCD panel 31 to display the image frame. The memory 32 stores a system application 321, a plurality of setting parameters 322 and a lookup table 323 between the content descriptors and the scenario modes.

These setting parameters 322 are related to output effects of the television 3, such as image display effects and audio output effects. The scenario mode contains a default value of the setting parameter 322 and corresponds to at least one content descriptor.

The television 3 provides the operational interface 35 to allow a user to select the system application 321. The microprocessor 33 reads the system application 321 from the memory 32 through the memory controller 324 and executes the system application 321, so as to determine the type of the program to be displayed by the television 3 based on the content descriptor list 362 and the received content descriptor 361, and then select the corresponding scenario mode from the lookup table 323. The microprocessor 33 controls the LCD television controller 311 based on the default value of the setting parameter 322 contained in the selected scenario mode so as to adjust the displayed frame of the LCD panel 31. For example, the brightness, color temperature, saturation or image gamma value can be adjusted. Besides, if it is needed, the microprocessor 33 can also control the audio decoder 38 based on the default value of the setting parameter 322 contained in the selected scenario mode so as to adjust an output effect of the amplifier 381, such as turning on or off surround sound effect.

The OSD display processor 34 is applied to a CRT/LCD device and functions for generating some particular characters or symbols on the LCD panel 31. When changing channel or adjusting volume or image quality happens at the television 3, the LCD panel 31 can inform the user of the current states and therefore is an important signal generating device on the operational interface 35. It is to be noted that the above-described operations are provided for illustration but not for limitation. Moreover, the operation of switching among the scenario modes 341 is well known by people skilled in the art and need not be discussed at any length herein.

The operational interface 35, the rendering engine 39, the OSD processor 34 and the audio decoder 38 shown in FIG. 3 can be all realized in, but not limited to, a software manner by implementing a microprocessor running relevant applications.

Besides, different television systems usually have different coding rules for content descriptor, so their content descriptor lists are also different, so the television can store two or more lookup tables 323 for various TV systems, such as one for DVB-T system and the other for ATSC system, and the user can select the suitable lookup table via operational interface 35.

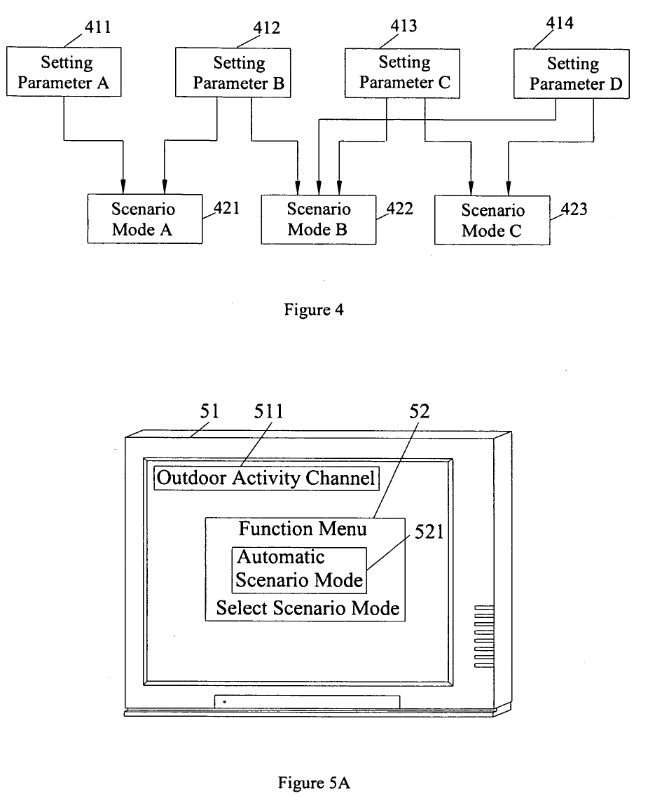

FIG. 4 illustrates a schematic drawing to explain the scenario modes of the television capable of changing its output effect based on program types disclosed in the present invention. Therein, a scenario mode A421 contains default values of a setting parameter A411 and another setting parameter B412. Another scenario mode B422 contains default values of setting parameters B412, C413 and D414. Still another scenario mode C423 contains default values of setting parameters C413 and D414. By selecting different scenario modes, different combinations of the default values of the setting parameters can be derived for adjusting the image display effects or the audio output effects of the television.

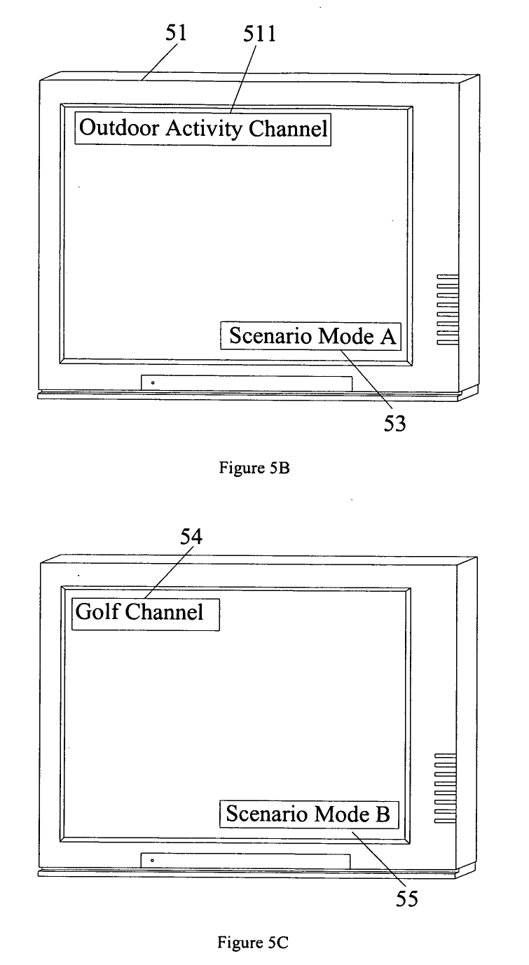

FIGS. 5A through 5C illustrate another embodiment of the television capable of changing is output effect based on programs types disclosed in the present invention. Therein, a television 51 provides a function menu 52 that contains items of automatic scenario mode 521 and a picking scenario mode. If a user selects the item of automatic scenario mode 521, when the user switches the television 51 to an outdoor activity channel 511, the television 51 determines a type of a program of the outdoor activity channel 511 based on a program classification list, and selects a scenario mode A 53 corresponding to the program type of the outdoor activity channel 511, as shown in FIG. 5B, so that the program of the outdoor activity channel 511 can be displayed with the desirable output effect.

Now referring to FIG. 5C, when the user switches to a golf channel 54, the television 51 automatically reads the program classification list to determine the type of the program in the golf channel 54 and selects a scenario mode B 55 corresponding to the program type of the golf channel 54 for adjusting the displayed frame.

It is learned from the above description that the television of the present invention allows users to easily select scenario modes to obtain enhanced output effects. Even when the user switches channels, the disclosed television can automatically determine a type of a program to be displayed and adjust the output effect based on the corresponding scenario mode.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A television capable of changing an output effect based on program types, comprising:
a receiving unit for receiving a television program signal and a program classification list, and the television program signal containing a program type information;
a storage unit for storing at least one setting parameter, and a lookup table recording the corresponding relationship between a plurality of program types and a plurality of scenario modes;
a processing unit for determining the type of the program being displayed based on the program classification list, and select a corresponding scenario mode from the lookup table;
an output unit for outputting the television program signal based on the selected scenario mode.

2. The television of claim 1, wherein the output unit comprises a display unit or an audio output unit.

3. The television of claim 2, wherein the scenario mode contains at least one image parameter for adjusting the output effect of the display unit, or at least one audio parameter for adjusting the output effect of the audio output unit.

4. The television of claim 1, wherein the program classification list is one of a content descriptor provided by DVB-T (Digital Video Broadcasting-terrestrial) and a genre code provided by ATSC (Advanced Television System Committee).

5. A method for changing an output effect based on program types, which is applicable to a television and comprises following steps:
providing a program classification list and a lookup table recording the corresponding relationship between a plurality of program types and a plurality of scenario modes and storing the program classification list and the lookup table in the television;
receiving a television program signal containing a program type information at the television;
selecting the scenario mode corresponding to the program type information from the lookup table based on the classification list; and
adjusting the output effect of the television based on the selected scenario mode.

6. The method of claim 5, wherein the scenario mode contains at least one image parameter for adjusting image display effect of the television, or at least one audio parameter for adjusting audio output effect of the television.

7. The television of claim 5, wherein the program classification list is one of a content descriptor provided by DVB-T (Digital Video Broadcasting-terrestrial) and a genre code provided by ATSC (Advanced Television System Committee).
